(19) United States
(12) Patent Application Publication
(10) Pub. No.: US 2017/0312659 A1
(43) Pub. Date: Nov. 2, 2017

(54) FILTER ARRANGEMENT HAVING BURST DISC ARRANGEMENT

(71) Applicant: Donaldson Company, Inc., Minneapolis, MN (US)

(72) Inventor: Scott GROSSBAUER, Eagan, MN (US)

(73) Assignee: Donaldson Company, Inc., Minneapolis, MN (US)

(21) Appl. No.: 15/513,515

(22) PCT Filed: Sep. 30, 2015
(86) PCT No.: PCT/US15/53247

§ 371 Date: Mar. 22, 2017

Related U.S. Application Data
(60) Provisional application No. 62/058,245, filed on Oct. 1, 2014.

(51) Int. Cl. B01D 29/21; B01D 46/00; B01D 35/147; B01D 29/23; B01D 29/54; B01D 46/24; B01D 35/143; B01D 29/00; B01D 35/00

(52) U.S. Cl. CPC B01D 29/21; B01D 46/2414; B01D 46/0024; B01D 35/147; B01D 35/143; B01D 29/232; B01D 29/54; B01D 35/00; B01D 29/00

(57) ABSTRACT

A filter arrangement includes a first filter media construction having a burst disc arrangement that is triggerable to rupture and open a flow path through the media construction. The first filter media construction can be oriented within the interior volume of a second filter media construction.

This application is being filed on 30 Sep. 2015, as a PCT International Patent application and claims the benefit of priority of U.S. Provisional patent application Ser. No. 62/058,245, filed Oct. 1, 2014, the entire disclosure of which is incorporated by reference in its entirety.

### TECHNICAL FIELD

This disclosure relates to filtration. In particular, this disclosure relates to filtration used in engines, generators, or various industrial applications.

### BACKGROUND

Filters are used in many types of systems including, for example, engines, generators, hydraulic, mobile, and various industrial applications to remove debris from fluid that is used to operate the system. After use for some time, the filter becomes occluded. In some filtration systems, a bypass valve is used to allow the fluid to flow around the filter, when it becomes plugged. The disadvantage of these types of systems is that fluid that bypasses the filter is not purified, which can cause damage to system components. Improvements are desirable.

### SUMMARY

A filter arrangement is provided to improve the prior art.

In general, a filter arrangement is provided that has a first filter media construction having a burst disc arrangement that is triggerable to rupture and open a flow path through the media construction.

In some arrangements, the first filter media construction has an interior volume, a first end, and a second opposite end. The first end is a closed end. The burst disc arrangement is on the second end. The burst disc arrangement closes the second end and blocks access to the interior volume. The burst disc is triggerable to rupture and open a flow path through the second end and into the interior volume.

The burst disc arrangement may be constructed and arranged to rupture responsive to a measured physical property. The measured physical property can include, for example, pressure drop, time passage, etc.

The burst disc arrangement may be constructed and arranged to rupture responsive to a manual force applied thereto.

The burst disc arrangement may be constructed and arranged to rupture responsive to a mechanical force automatically triggered by an event, such as pressure drop, time passage, etc.

The arrangement can include an indicator that signals when the burst disc arrangement has ruptured.

The arrangement can include a second filter media construction having a second interior volume, and wherein the first filter media construction is operably positioned within the second interior volume.

The second filter media construction can include first and second opposite ends. The first end can be an open end in communication with the second interior volume. The second end can be a closed end blocking access to the second interior volume.

In some arrangements, the second filter media construction second end can be radially spaced from and even with the first filter media construction second end.

The second filter media construction first end is radially and axially spaced from the first filter media construction first end.

A brace arrangement can be provided between the second filter media construction and the first filter media construction.

The brace arrangement may be between the second filter media construction first end and the first filter media construction first end.

The burst disc arrangement may be constructed and arranged to rupture responsive to a pressure drop across the second filter media construction.

The burst disc arrangement may be constructed and arranged to rupture responsive to a manual force applied thereto.

In another aspect, a filter assembly is provided. The filter assembly includes a housing and a filter arrangement as characterized in any of the ways above operably installed within the housing.

In another aspect, a filter system is provided. The filter system may include an engine utilizing fluids to be filtered and a filter assembly as characterized above operably connected to the engine to filter the fluids.

In another aspect, a method of filtering is provided. The method of filtering includes a step of directing a fluid to be filtered through the filter arrangement as variously characterized above.

The method can include rupturing the burst disc arrangement to permit fluid to flow through the second end, into the interior volume, and then through the first filter media construction.

In another aspect, a method of filtering includes directing fluid to be filtered through an outer filter media construction and opening a burst disc to allow the fluid to be filtered through an inner filter media construction.

The step of opening a burst disc may include measuring the pressure drop across the outer filter media construction, and when the pressure drop exceeds a predetermined amount, opening the burst disc.

The step of opening a burst disc may include manually opening the burst disc.

The method may include providing an outer filter media construction having an interior volume, first and second opposite ends, with the first end being in communication with the interior volume and the second end being a closed end blocking access to the interior volume; and providing the inner filter media construction operably positioned within the interior volume of the outer filter media construction; the inner filter media construction having an interior volume, a first closed end, and a second end closed by the burst disc, the burst disc being triggerable to rupture and open a flow path through the inner filter media constructions second end and into the inner filter media construction interior volume.

Any combination or sub-combination of the features are contemplated herein.

### BRIEF DESCRIPTION OF THE DRAWINGS

FIG. 1 is a schematic cross-sectional view of one embodiment of a filter arrangement constructed in accordance with principles of this disclosure;

FIG. 2 is a schematic, cross-sectional view of the filter arrangement of FIG. 1 and showing the burst disc arrangement in a ruptured position;

FIG. 3 is a schematic, perspective view of a filter assembly including the filter arrangement of FIGS. 1 and 2 operably assembled in a housing;

FIG. 4 is a schematic, cross-sectional view similar to that of FIG. 1, and showing a manual force for opening the burst disc; and

FIG. 5 is a schematic view of a system utilizing the filter assembly constructed in accordance with principles of this disclosure.

### DETAILED DESCRIPTION

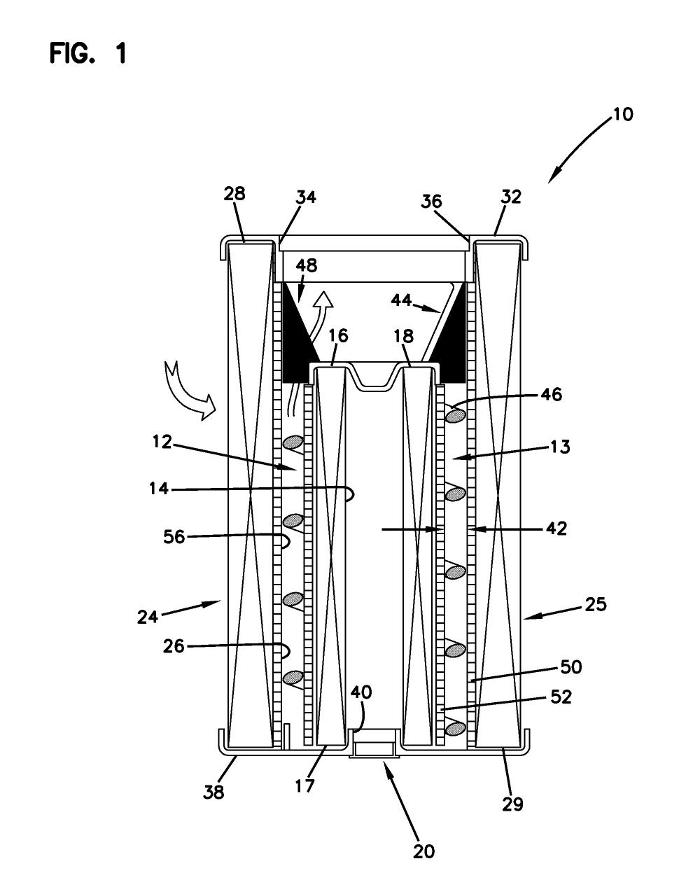

FIG. 1 is a schematic, cross sectional view of an embodiment of a filter arrangement 10. In one or more example embodiments, FIG. 1 depicts an improvement of the construction shown in U.S. Pat. No. 7,837,754, incorporated herein by reference.

The filter arrangement 10 includes a first filter media construction 12. The first filter media construction 12 can be constructed as a construction of media arranged in a tube, which can be cylindrical or other shapes, so that it defines an interior volume 14. In preferred implementations, the first filter media construction 12 will be an inner filter media construction 13 with the interior volume 14.

The first filter media construction 12 has first and second opposite ends 16, 17. One of the first and second ends 16, 17 can be a closed end, meaning that it is not in open communication with the interior volume 14. In the example shown, the first end 16 is a closed end.

The filter arrangement 10 includes a burst disc arrangement 20. The burst disc arrangement 20 is triggerable to rupture and open a flow path into the interior volume 14 of the first filter media construction 12.

In the example shown in FIG. 1, the burst disc arrangement 20 is adjacent the second end 17. As depicted in the drawings, the burst disc arrangement 20 is on the second end 17. The burst disc arrangement 20 closes the second end 17 and blocks access to the interior volume 14. Upon rupturing, the burst disc 20 opens a flow path through the second end 17 and into the interior volume 14.

In some embodiments, the burst disc arrangement 20 is constructed and arranged to rupture responsive to a measure physical property. The measured physical property can be, for example, pressure drop. Other physical properties are possible, as well.

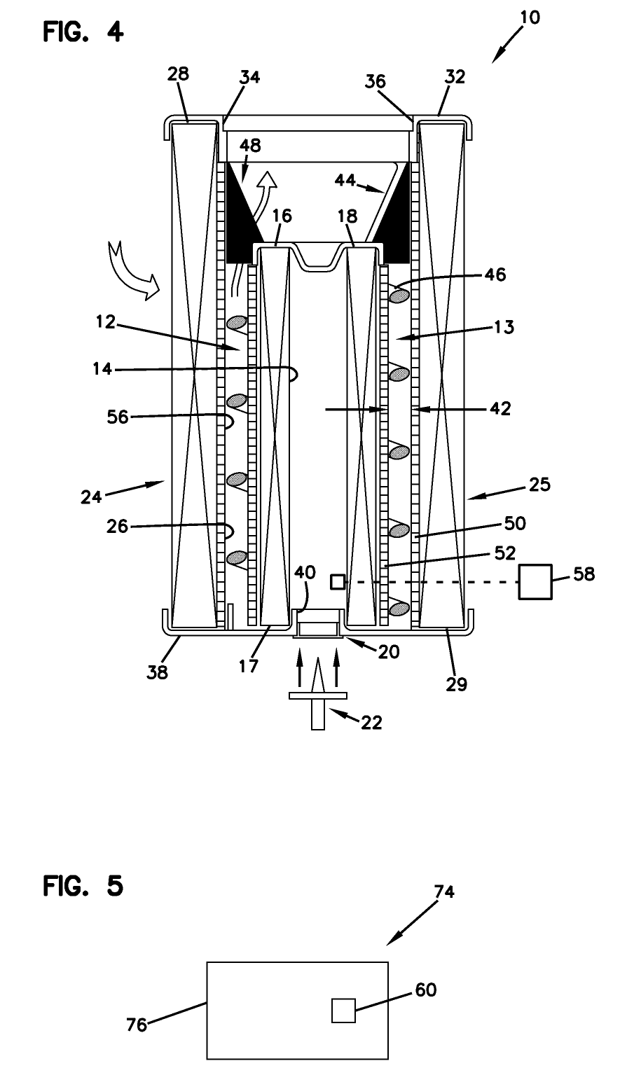

In some implementations, the burst disc arrangement 20 is constructed and arranged to rupture responsive to a manual force applied thereto. For example, FIG. 4 illustrates a plunger assembly 22, which could be manually actuated in order to breach or rupture the burst disc arrangement 20.

The first filter media construction 12 can be any type of filter media. For example, the media can be pleated media or depth media. The pleated media can be cellulose, synthetic, or various blends.

The first end 16 of the first filter media construction 12 has a closed first end cap 18 secured thereto and blocking access to the interior volume 14.

Still in reference to FIG. 1, the filter arrangement 10 includes a second filter media construction 24. The second media construction 24 can be in the form of a tube (cylindrical or other shapes) having a second interior volume 26.

The second filter media construction 24, in the arrangement shown, may also be referred to an outer filter media construction 25 because of its relationship to the first filter media construction 12 as depicted in FIG. 1. For example, as shown in FIG. 1, the first filter media construction 12 is operably positioned within the second interior volume 26 of the second filter media construction 24. Thus, as depicted in FIG. 1, the first filter media construction 12 is the inner filter media construction 13, while the second filter media construction 24 is the outer filter media construction 25.

The second filter media construction 24 can be any type of media. For example, it can be pleated media, or it can be depth media, or other types. The media can be made from cellulose, synthetic media, or blends thereof.

The relative efficiencies of the second filter media construction 24 and the first filter media construction 12 may be the same, or they may be different. In some arrangements, the efficiency of the first filter media construction 12 will be less efficient than that of the second filter media construction 24.

The second filter media construction includes first and second opposite ends 28, 29. The first end 28 is an open end in open communication with the second interior volume 26. The second end 29 is a closed end which blocks access to the second interior volume 26.

In the example embodiment of FIG. 1, the first end 28 has a first end cap 32 secured to the first end 28. The first end cap 32 defines an opening 34, which is in communication with the second interior volume 26.

In examples where the filter arrangement 10 operates in a forward-flow (outside to in) operation, the opening 34 functions as a filtered fluid outlet 36.

The second end 29 of the second filter media construction 24 has a second end cap 38 secured thereto. The second end cap 38 closes the second end 29 and blocks access to the second interior volume 26.

In the example shown in FIG. 1, the second end cap 38 can also be secured to the second end 17 of the first filter media construction 12.

In one or more example embodiments, the second end cap 38 has an opening 40 that is only opening into the interior volume 14 of the first filter media construction 12. This opening 40 is blocked or closed by the burst disc arrangement 20.

In the embodiment of FIG. 1, the filter arrangement 10 illustrates how the second filter media construction 24 is radially spaced from the first filter media construction 12 so that there is a radial gap 42 in between.

In some embodiments, the radial gap 42 between the first filter media construction 12 and second filter media construction 24 has a brace arrangement 44 there between. Examples of usable brace arrangements are described in U.S. Pat. No. 7,837,754, incorporated herein by reference. For example, the brace arrangement 44 can be a spring 46. Alternatively, the brace arrangement 44 can be a gusset arrangement 48. In the example shown, both the spring 46 and gusset arrangement 48 are used. In other embodiments, the brace arrangement 44 will include only a spring 46 or only a gusset arrangement 48, and not both. In still further arrangements, the filter arrangement 10 does not include a brace arrangement 44 at all. That is, the brace arrangement 44 is an optional feature.

In this illustrated example, the second filter media construction second end 29 is radially spaced from and even with the first filter media construction second end 17. When arranged in this manner, the second end cap 38 can be used to secure the media constructions for both the first filter media construction 12 and second filter media construction 24.

In this example embodiment, the second filter media construction first end 28 is radially and optionally axially spaced from the first filter media construction first end 16. The optional brace arrangement 44 may be placed between the second filter media construction first end 28 and the first filter media construction first end 16. For example, the gusset arrangement 48 can be shown optionally extending between and connected to the first end cap 18 of the first filter media construction 12 and the first end cap 32 of the second filter media construction 24.

Other optional features of the filter arrangement 10 include an inner liner 50 of the second filter media arrangement 24, to support the media construction 24. When used, the inner liner 50 extends between the first end cap 32 and second end cap 38.

The first filter media construction 12 may include an optional outer liner 52. The outer liner 52, when used, extends between the second end cap 38 and the first end cap 18 of the first filter media construction 12.

Fluid flows through the filter arrangement 10 illustrated by the arrows shown in FIG. 1. Fluid to be filtered will enter the filter arrangement 10 from a volume outside of the second filter media construction 24, which is the outer filter media construction 25. The fluid to be filtered will flow through the media in the second filter media construction 24, which will remove at least some particulate. The fluid will flow into a filtered fluid volume 56, which is in the second interior volume 26, and then leave the filter arrangement 10 by flowing through the opening 34, operating as a filtered fluid outlet 36. Initially, when the burst disc arrangement 20 is not ruptured, there will be no flow through the first filter media construction 12.

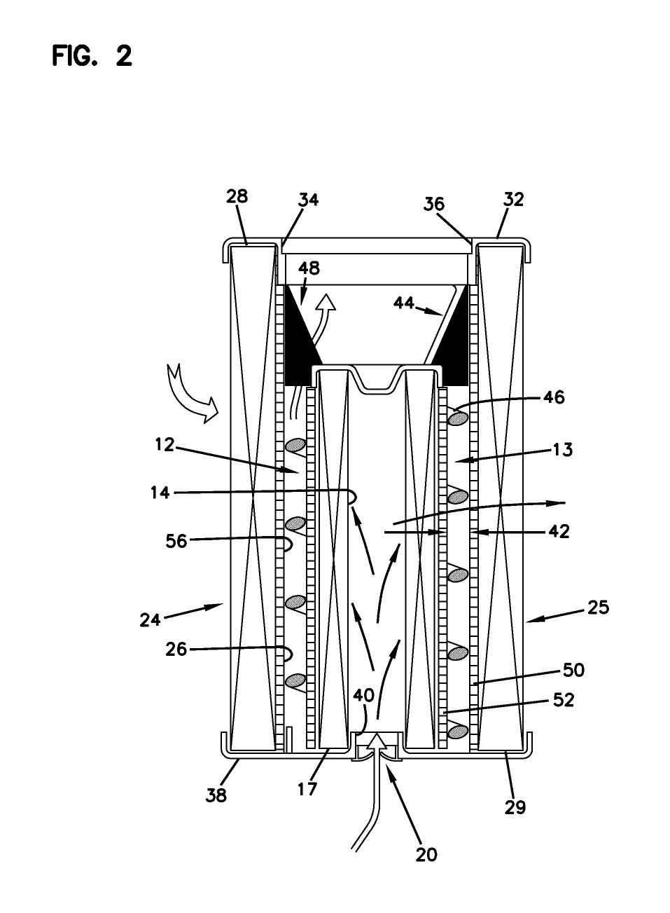

FIG. 2 illustrates flow through the filter arrangement 10 when the burst disc arrangement 20 has been ruptured. Fluid to be filtered will enter both the second filter media construction 24 and will flow through the opening 40 in the second end cap 38 and enter into the interior volume 14 of the first filter media construction 12. That is, the flow through the first filter media construction 12 is in parallel to the flow through the second filter media construction 24. The rate of flow through each of the first filter media construction 12 and second filter media construction 24 will depend on the pressure drop (resistance) across each. From there, the fluid will flow through the media of the first filter media construction 12, where particulate will be removed. The filtered fluid will then flow into filtered fluid volume 56, which is the interior volume 26 of the second filter media construction 24. The filtered liquid will then exit the filter arrangement by flowing through the filtered fluid outlet 36 through the opening 34.

The burst disc arrangement 20, in some embodiments, is constructed and arranged to rupture responsive to a pressure drop across the second filter media construction 24. That is, when the second filter media construction 24 starts to occlude, the pressured drop will rise. A pressure indicator will detect the rise in pressure drop. Upon exceeding a predetermined pressure drop amount, the burst disc arrangement 20 will be triggered to rupture or open to open the additional fluid path through the first filter media construction 12.

Alternatively, as mentioned above, the burst disc arrangement 20 can optionally have a way to rupture responsive to a manual force, such as the plunger assembly 22 of FIG. 4.

Alternatively, the burst disc arrangement 20 may be constructed and arranged to rupture responsive to a mechanical force triggered by an event, such as pressure drop, time passage, etc.

In preferred implementations, the filter arrangement 10 will include an indicator 58 (FIG. 4) that will signal when the burst disc arrangement 20 has been ruptured. The indicator 58 will communicate to a person operating the equipment in which the filter arrangement 10 is used to tell the operator that it is time to replace the filter arrangement 10.

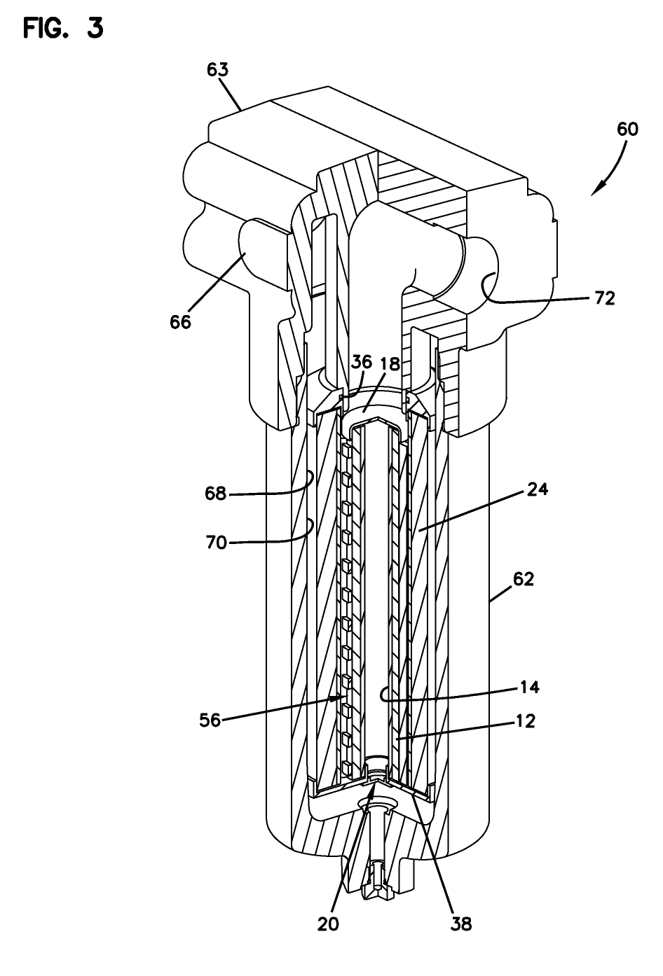

The filter arrangement can be part of a filter assembly 60. One example filter assembly 60 is shown in FIG. 3. The filter arrangement 10 can be operably installed within a housing 62 and connected to a filter head 64. For the filter assembly 60, fluid to be filtered enters the filter head 64 through an inlet 66. The fluid then flows into an unfiltered fluid volume 68, which is the volume between an inside surface 70 of the housing 62 and the outer periphery of the second filter media construction 24. The fluid flows from the unfiltered fluid volume 68, through the second filter media construction 24, and into the filtered fluid volume 56. From there, it flows through the filtered fluid outlet 36 and then leaves the filter head 64 through an outlet 72. When the burst disc arrangement 20 is ruptured, the fluid flows from the unfiltered fluid volume 68, through the opening 40, and into the interior volume 14. From there, it flows through the first filter media construction 12 and into the filtered fluid volume 56. Fluid may also be flowing through the second filter media construction 24. From the filtered fluid volume 56, the fluid then flows through the filtered fluid outlet 36 and then leaves the filter head 64 through the outlet 72.

The filter assembly 60 can be part of a filter system 74. The filter system 74, FIG. 5, can include an engine 76. The engine 76 will utilize fluids to be filtered. These fluids can be gas or liquid. For example, these fluids can be fuel or oil. The filter assembly 60 will be operably connected to the engine 76 to filter the fluids.

A method of filtering generally can include directing fluid to be filtered through an outer filtered media construction, such as the outer filter media construction 25. The method further includes opening a burst disc, such as the arrangement shown at 20, to allow the fluid to be filtered through an inner filter media construction, such as the inner filter media construction 13.

The step of opening a burst disc may include measuring the pressure drop across the outer filter media construction 25, and when the pressure drop exceeds a predetermined amount, opening the burst disc.

The step of opening a burst disc can include manually opening the burst disc. In one or more example methods, the step of manually opening the burst disc can include using a plunger assembly, such as plunger assembly 22.

When the burst disc arrangement 20 is ruptured, the inner filter media construction 13 becomes available for use as a filter. Thus, it can be appreciated that the inner filter media construction 13 operates as reserve media, which becomes available when the pressure drop across the outer filter media construction 25 exceeds a predetermined amount. The indicator 58 can be used to warn the operator that it is time to change the filter.

In some example systems, the burst disc arrangement 20 will operate with diesel fuel. On one side, the burst disc arrangement 20 is exposed to fuel at atmospheric pressure. On the other side, the burst disc arrangement 20 is exposed to fuel at a vacuum of up to about 1 bar. In one or more example implementations, the burst disc arrangement 20 ruptures at a pressure of greater than 0.5 bar; for example, it can rupture at greater than 0.6 bar and including rupturing at about 0.7 bar. The burst area can be about 0.5 sq. inches, contained within a total area of about 7 sq. inches.

The above presents example principles. Many embodiments can be made utilizing any combination of these principles.

1. A filter arrangement comprising:
(a) a first filter media construction defining an interior volume; the first filter media construction having first and second opposite ends;
(b) the first end being a closed end; and
(c) a burst disc arrangement on the second end; the burst disc arrangement closing the second end and blocking access to the interior volume; the burst disc arrangement being triggerable to rupture and open a flow path through the second end and into the interior volume;
(d) a second filter media construction having a second interior volume; and wherein the first filter media construction is operably positioned within the second interior volume.

2. The filter arrangement of claim 1 wherein:
(a) the burst disc arrangement is constructed and arranged to rupture responsive to a measured physical property.

3. The filter arrangement of claim 1 wherein:
(a) the burst disc arrangement is constructed and arranged to rupture responsive to a manual force applied thereto.

4. The filter arrangement of claim 1 further comprising:
(a) an indicator that signals when the burst disc arrangement has ruptured.

5. (canceled)

6. The filter arrangement of claim 1 wherein:
(a) the second filter media construction includes opposite ends; a first of the opposite ends being an open end in communication with the second interior volume; and a second of the opposite ends being a closed end blocking access to the second interior volume.

7. The filter arrangement of claim 6 wherein:
(a) the second filter media construction second end is radially spaced from and even with the first filter media construction second end.

8. The filter arrangement of claim 7 wherein:
(a) the second filter media construction first end is radially and axially spaced from the first filter media construction first end.

9. The filter arrangement of claim 1 further comprising:
(a) a brace arrangement between the second filter media construction and the first filter media construction.

10. The filter arrangement of claim 6 further comprising:
(a) a brace arrangement between the second filter media construction first end and the first filter media construction first end.

11. The filter arrangement of claim 1 wherein:
(a) the burst disc arrangement is constructed and arranged to rupture responsive to a pressure drop across the second filter media construction.

12. The filter arrangement of claim 1 wherein:
(a) the burst disc arrangement is constructed and arranged to rupture responsive to a manual force applied thereto.

13. The filter arrangement claim 1 wherein:
(a) The burst disc arrangement may be constructed and arranged to rupture responsive to a mechanical force automatically triggered by an event.

14. A filter assembly comprising:
(a) a housing; and
(b) a filter arrangement according to claim 1 operably installed therein.

15. A filter system comprising:
(a) an engine utilizing fluids to be filtered; and
(b) a filter assembly according to claim 14 operably connected to the engine to filter the fluids.

16. (canceled)

17. (canceled)

18. A method of filtering comprising:
(a) directing fluid to be filtered through an outer filter media construction; and
(b) opening a burst disc to allow the fluid to be filtered through an inner filter media construction.

19. The method of claim 18 wherein:
(a) the step of opening a burst disc includes measuring the pressure drop across the outer filter media construction, and when the pressure drop exceeds a predetermined amount, opening the burst disc.

20. The method of claim 18 wherein:
(a) the step of opening a burst disc includes manually opening the burst disc.

21. The method of claim 18 wherein the step of directing fluid to be filtered through an outer filter media construction includes:
(a) providing an outer filter media construction having an interior volume, first and second opposite ends, with the first end being in communication with the interior volume and the second end being a closed end blocking access to the interior volume; and
(b) providing the inner filter media construction operably positioned within the interior volume of the outer filter media construction; the inner filter media construction having an interior volume, a first closed end, and a second end closed by the burst disc, the burst disc being triggerable to rupture and open a flow path through the inner filter media construction second end and into the inner filter media construction interior volume.
